(19) United States
(12) Patent Application Publication
(10) Pub. No.: US 2017/0137636 A1
(43) Pub. Date: May 18, 2017

(54) Graphene Composite Material and Preparation Method Thereof

(71) Applicant: Chung Yuan Christian University, Taoyuan City (TW)

(72) Inventors: Wei-Song Hung, Taoyuan City (TW); Chien-Chieh Hu, Taoyuan City (TW); Kueir-Rarn Lee, Taoyuan City (TW); Juin-Yih Lai, Taoyuan City (TW)

(21) Appl. No.: 14/953,399

(22) Filed: Nov. 29, 2015

(30) Foreign Application Priority Data
Nov. 13, 2015 (TW) 104137499

(51) Int. Cl. C09D 5/24

(52) U.S. Cl. CPC C09D 5/24

(57) ABSTRACT

The present invention relates to a graphene composite material and a preparation method thereof, wherein the preparation method of the graphene composite material comprises the steps of: providing a modification solution comprising a compound having catechol group, and a first solvent; adding a graphene material into the modification solution; and mixing the graphene material and the modification solution to form a graphene composite material.

### CROSS REFERENCE OF RELATED APPLICATION

This application claims the benefits of Taiwan Patent Application Serial Numbers 104137499, filed on Nov. 13, 2015, the subject matter of which is incorporated herein by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to a graphene composite material and preparation method thereof, particularly, to a graphene composite material that has good dispersibility in solvent and preparation method thereof.

Description of Related Arts

Graphene is a thin film composed of carbon atoms arranged in a two dimensional honeycomb lattice shape. Due to the strong interatomic force between the carbon atoms of graphene, the graphene film is still robust and sturdy even the thickness of the graphene film is only single-atom-thick. In addition to the advantage of strong mechanical strength that mentioned above, graphene is also characterized by excellent thermal conductivity, electrical conductivity, and light transmittance, so that graphene may be applied in a wide range of applications. For example, graphene material may be applied in communication systems, solar panels, battery materials, touch panel and other electronic devices. On the other hand, graphene may also be a potential material for biomedical engineering, environmental engineering, or other technical fields.

Graphene is characterized by superior carrier mobility and current capacity, and is currently the most potential material in the field of electronical devices due to its high flexibility and high light-transmittance. For example, graphene may be utilized in flexible electronic devices for replacing the indium tin oxide (ITO) conductive thin film known in the art. The electrodes made of graphene thin film may show greater flexibility, light-transmittance and stability comparing to the ITO thin film.

The conventional method for preparing graphene comprises mechanical exfoliation, chemical exfoliation, chemical vapor deposition, or epitaxial growth method, etc. However, the aforementioned methods are not suitable for mass production and the application in practice is limited due to the high cost of production thereof. A novel preparation method of graphene is to prepare graphene oxide at first, and perform a reduction reaction to obtain graphene. This preparation method is suitable for mass production, but has the disadvantages of long reaction time, high reaction temperature, and the reagent used for the reduction reaction is likely to cause environmental pollution. Also, the quality of the prepared graphene may be poor and lacking of electrical conductivity due to the incomplete reduction of the graphene oxide, therefore, the applicability of the graphene cannot be improved. In addition, graphene is a nano-carbon material having high specific surface area, which aggregates essentially in water and results in poor dispersibility. Hence, graphene barely disperse in solvent uniformly, and the conduction between graphene fragments cannot be assured, thus affecting the conductivity of graphene thin film prepared thereby which is loosely structured and lacking of densification.

Accordingly, it is desirable to provide a preparation method of graphene composite material that can be performed in a moderated condition with lower cost, and the graphene composite material prepared thereby is characterized by high dispersibility in solvent. The graphene composite material may further be utilized to form a dense graphene composite material thin film in order to improve the electrical conductivity of the graphene thin film and increase the application potential of the graphene thin film in electronic devices.

### SUMMARY OF THE PRESENT INVENTION

In order to mitigate the aforementioned problems, the present invention provides a preparation method of a graphene composite material, which comprise the steps of: (A) providing a modification solution, wherein the modification solution comprises a compound having catechol group, and a first solvent; (B) adding a graphene material into the modification solution; and (C) mixing the graphene material and the modification solution to obtain a graphene composite material.

According to the graphene composite material prepared by the preparation method of the present invention, the compound having catechol group is coated on the surface of the graphene material.

According to a preferred embodiment of the present invention, wherein in step (A), the modification solution may comprise 0.01 to 10 parts by weight of the compound having catechol group based on 100 parts by weight of the first solvent. Preferably, the compound having catechol group may be at least one selected from the group consisting of dopa, dopamine, catechol, norepinephrine, 3,4-dihydroxybenzoic acid, 3,4-dihydroxyphenyl acetic acid, caffeic acid, 4-methylcatechol, 4-tert-butylcatechol, salts thereof, and derivatives thereof. Further, the first solvent is preferably selected from the group consisting of water, alcohols, and a mixture thereof.

In the aforementioned step (A), the amount of the compound having catechol group in the modification solution is preferably 0.1 to 5 parts by weight, and is more preferably 0.2 to 1 parts by weight. The first solvent is more preferably water. The compound having catechol group is more preferably at least one selected from the group consisting of dopa, dopamine, catechol, salts thereof, and derivatives thereof.

Furthermore, according to a preferred embodiment of the present invention, wherein in step (A), the modification solution may further comprises 0.01 to 1.5 parts by weight of a pH adjusting agent, such that the modification solution may have a pH value of 6 to 11. The pH adjusting agent is preferably tris(hydroxymethyl)aminomethane (Tris).

In the aforementioned step (A), the amount of the pH adjusting agent in the modification solution is preferably 0.05 to 1 parts by weight, and more preferably 0.1 to 0.9 parts by weight, so that the modification solution is preferably to have a pH value of 7 to 10.

Furthermore, according to a preferred embodiment of the present invention, wherein in step (B), the amount of the graphene material being added is preferably 1 to 7 parts by weight. In addition, single-layer graphene film, multi-layer graphene film, or modified graphene film may be utilized as the graphene material in the present invention.

In the aforementioned step (B), the amount of the graphene material being added is more preferably 3 to 5 parts by weight, and is most preferably 4 parts by weight. The graphene material is preferably single-layer graphene film or multi-layer graphene film.

In addition, according to the a preferred embodiment of the present invention, wherein in step (C), the method of mixing the graphene material with the modification solution is not particularly limited as long as the compound having catechol group in the modification solution and the graphene material may be well-mixed and be dispersed in a homogeneous state. For example, methods of sonication, mechanical agitation, or mechanical milling may be applied. Further, the modification temperature of mixing the graphene material and the modification solution is preferably 10° C. to 100° C., and the duration time of modification is not particular limited as long as the compound having catechol group in the modification solution and the graphene material may be well-mixed and be dispersed in a homogeneous state. According to a preferred embodiment of the present invention, the duration time of modification is preferably 60 minutes to 720 minutes.

In the aforementioned step (C), the method for mixing the graphene material and the modification solution is preferable to be sonication. Moreover, the graphene material and the modification solution being mixed at 20° C. to 90° C. is more preferable, and being mixed at 30° C. to 80° C. is most preferable.

According to the preparation method of graphene composite material of the present invention, the obtained graphene composite material is suspended in a suspension solution, and the graphene composite material may be collected by any solid-liquid separation method known in the art such as filtration, and the collected solid phase is dried to obtained the graphene composite material powder.

Accordingly, the preparation method of graphene composite material may further comprises a step (D): removing the first solvent to obtain a graphene composite material powder. In addition, the preparation method of graphene composite material may further comprise the steps of (E1): distributing the graphene composite material powder in a second solvent to form a graphene composite material mixture solution; and (E2): providing the graphene composite material mixture solution on a substrate, and removing the second solvent to obtain a graphene composite material thin film.

According to a preferred embodiment of the present invention, the second solvent is preferably water. Owning to the high dispersibility of the graphene composite material in water, the prepared graphene composite material powder may be deposited on a substrate to form a dense graphene composite material thin film using vacuum filtration method or other related deposition method.

It is another object of the present invention to provide a graphene composite material, which is prepared by the preparation method of the graphene composite material that described above. The graphene composite material comprises: 70 to 99.9 wt % of a graphene material; and 0.1 to 30 wt % of a compound having catechol group, wherein the compound having catechol group is coated on the surface of the graphene material.

The aforementioned graphene composite material preferably comprises 90 to 99.5 wt % of the graphene material, and 0.5 to 10 wt % of the compound having catechol group; and more preferably comprises 91.8 to 97.3 wt % of the graphene material, and 2.7 to 8.2 wt % of the compound having catechol group.

According to the aforementioned graphene composite material, the graphene material is preferably a single-layer graphene film, a multi-layer graphene film, or a modified graphene; and the compound having catechol group is preferably at least one selected from the group consisting of dopa, dopamine, catechol, norepinephrine, 3,4-dihydroxybenzoic acid, 3,4-dihydroxyphenyl acetic acid, caffeic acid, 4-methylcatechol, 4-tert-butylcatechol, salts thereof, and derivatives thereof.

According to the aforementioned graphene composite material, wherein the graphene material is preferably the single-layer graphene film or the multi-layer graphene film; and the compound having catechol group is preferably at least one selected from the group consisting of dopa, dopamine, catechol, norepinephrine, salts thereof, and derivatives thereof.

### BRIEF DESCRIPTION OF THE DRAWINGS

FIG. 1 is a dispersion diagram of the graphene prepared by Comparative examples 1 and the graphene composite material prepared by Comparative examples 3 and 4 of the present invention;

FIG. 2 is a dispersion diagram of the graphene composite material prepared by Comparative example 2 and Examples 1-8 of the present invention.

FIG. 3 is a SEM image of the surface of the graphene composite material thin film prepared by Example 3 of the present invention;

FIG. 4 is a SEM image of the cross-section of the graphene composite material thin film prepared by Example 3 of the present invention;

FIG. 5 is a TEM image of the graphene composite material thin film prepared by Example 3 of the present invention;

FIG. 6 is a SEM image of the surface of the graphene material thin film prepared by Comparative example 1 of the present invention;

FIG. 7 is a SEM image of the section of the graphene material thin film prepared by Comparative example 1 of the present invention;

FIG. 8 is a TEM image of the graphene material thin film prepared by Comparative example 1 of the present invention;

### DETAILED DESCRIPTION OF THE PREFERRED EMBODIMENT

Hereafter, examples will be provided to illustrate the embodiments of the present invention. Advantages and effects of the invention will become more apparent for person skilled in the art from the disclosure of the present invention. Other various aspects also may be practiced or applied in the invention, and various modifications and variations can be made without departing from the spirit of the invention based on various concepts and applications.

### Example 1

In the present example, the preparation method of the graphene composite material started with providing a modification solution including 100 g of deionized water as the solvent and 0.2 g of dopamine that dissolved in the deionized water. Next, 4 g of graphene powder (N002-PDR Graphene Powder, Angstron materials Inc.) was added to the modification solution which was then being sonicated at 30° C. for 60 minutes for modification. The obtained graphene composite material was homogeneously dispersed in the solution, wherein the content of dopamine in the obtained graphene composite material was 2.8 wt %. In the present example, the deionized water may be removed using a filtration method, and the resulting solid phase was then dried to obtain the graphene composite material powder. The graphene composite material powder was further dispersed in water for forming a graphene composite material mixture solution, and the graphene composite material mixture solution was provided to a vacuum filtration apparatus having a porous substrate, where the graphene composite material mixture solution was vacuum-filtrated and dried for forming a graphene composite material thin film.

### Example 2

In the present example, the preparation process was substantially the same as described in Example 1 except that the modification solution further comprised 0.9 g of Tris(hydroxymethyl)aminomethane (Tris) as a pH adjusting agent so that the pH value of the modification solution of the present example became 10. The content of dopamine in the graphene composite material prepared by the present example was 4.1 wt %. In this example, the process for preparing the graphene composite material thin film was the same as described in Example 1.

### Example 3

In the present example, the preparing method of the graphene composite material started with providing a modification solution including 100 g of deionized water as the solvent, 0.2 g of dopamine that dissolved in the deionized water, and 0.1 g of Tris as a pH adjusting agent so that the pH value of the modification solution of the present example was 8.5. Next, 4 g of graphene powder (N002-PDR Graphene Powder, Angstron materials Inc.) was added to the modification solution and was sonicated at 30° C. for 60 minutes for modification. The obtained graphene composite material was homogeneously dispersed in the solution, wherein the content of dopamine in the obtained graphene composite material was 3.2 wt %. In the present example, the deionized water may be removed using filtration method, and the resulting solid phase was then dried to obtain the graphene composite material powder. The graphene composite material powder was further dispersed in water to form a graphene composite material mixture solution. The graphene composite material mixture solution was then provided to a vacuum filtration apparatus having a porous substrate, where the graphene composite material mixture solution was vacuum-filtrated and dried for forming a graphene composite material thin film.

### Example 4

The preparation process of the present example was substantially the same as described in Example 3 except that dopamine in the modification solution was replaced by 0.2 g of dopa. The content of dopa in the graphene composite material prepared by the present example was 2.7 wt %. In this example, the process for preparing the graphene composite material thin film was the same as described in Example 3.

### Example 5

The preparation process of the present example was substantially the same as described in Example 3 except that dopamine in the modification solution was replaced by 0.2 g of catechol. The content of catechol in the graphene composite material prepared by the present example was 3.1 wt %. In this example, the process for preparing the graphene composite material thin film was the same as described in Example 3.

### Example 6

The preparation process of the present example was substantially the same as described in Example 3 except that the content of dopamine in the modification solution was 1.0 g. The content of dopamine in the graphene composite material prepared by the present example was 8.2 wt %. In this example, the process for preparing the graphene composite material thin film was the same as described in Example 3.

### Example 7

The preparation process of the present example was substantially the same as described in Example 3 except that the graphene powder was sonicated in the modification solution for 720 minutes. The content of dopamine in the graphene composite material was 4.3 wt %. In this example, the process for preparing the graphene composite material thin film was the same as described in Example 3.

### Example 8

The preparation process of the present example was substantially the same as described in Example 3 except that the graphene powder was sonicated in the modification solution at 80° C. In this example, the process for preparing the graphene composite material thin film was the same as described in Example 3.

### Comparative Example 1

In this comparative example, 4 g of graphene powder (N002-PDR Graphene Powder, Angstron materials Inc.) was directly added into 100 g of deionized water, and was then sonicated in the deionized water at 30° C. for 60 minutes for forming a suspension solution of graphene. In the present comparative example, the suspension solution of graphene may then be further provided to a vacuum filtration apparatus having a porous substrate. The suspension solution of graphene was vacuum-filtrated and dried for forming a graphene film.

### Comparative Example 2

The present comparative example provided a modification solution including 100 g of deionized water as the solvent and 0.2 g of fatty alcohol sulfate as the anionic dispersing agent that dissolved in the deionized water. Next, 4 g of graphene powder (N002-PDR Graphene Powder, Angstron materials Inc.) was added into the modification solution which was then sonicated at 30° C. for 60 minutes for modification. The obtained graphene composite material was dispersed in the solution, and the content of fatty alcohol sulfate in the graphene composite material was 2.1 wt %. In this comparative example, deionized water may be removed by filtration, and the resulting solid phase was then dried to obtain the graphene composite material powder. The graphene composite material powder was then be further dispersed in water to form a graphene composite material mixture solution, and the graphene composite material mixture solution was provided to a vacuum filtration apparatus having a porous substrate. The graphene composite material mixture solution was vacuum-filtrated and dried for forming a graphene composite material thin film.

### Comparative Example 3

The preparation process of the present comparative example was substantially the same as described in Comparative example 2 except that the fatty alcohol sulfate anionic dispersing agent was replaced by 0.2 g of fatty alcohol ethoxylate as the cationic dispersing agent. The content of fatty alcohol ethoxylate in the resulting graphene composite material was 1.2 wt %. In this comparative example, the process for preparing the graphene composite material thin film was the same as described in Comparative example 2.

### Comparative Example 4

The preparation process of the present comparative example was substantially the same as described in Comparative example 2 except that the fatty alcohol sulfate anionic dispersing agent was replaced by 0.2 g of betaine(trimethylglycine) as the nonionic dispersing agent. The content of betaine(trimethylglycine) in the resulting graphene composite material was 2.3 wt %. In this comparative example, the process for preparing the graphene composite material thin film was the same as described in Comparative example 2.

TABLE 1

| | | Weight of the | Weight | | Weight of | | | | |
|---|---|---|---|---|---|---|---|---|---|
| | | compound | of the pH | | the | | | | |
| | Weight of | having catechol | adjusting | | graphene | Modification | Modification | | Electrical |
| | the first | group | agent | pH | material | time | temperature | | Conductivity |
| | solvent (g) | (g) | (g) | value | (g) | (min) | (° C.) | Dispesibility | (S/m) |
| Example 1 | Deionized | dopamine | — | 7 | graphene | 60 | 30 | good | 6.25 × 10⁴ |
| | water | (0.2 g) | | | (4 g) | | | | |
| | (100 g) | | | | | | | | |
| Example 2 | Deionized | dopamine | Tris | 10 | graphene | 60 | 30 | good | 9.34 × 10⁴ |
| | water | (0.2 g) | (0.9 g) | | (4 g) | | | | |
| | (100 g) | | | | | | | | |
| Example 3 | Deionized | dopamine | Tris | 8.5 | graphene | 60 | 30 | good | 2.17 × 10⁵ |
| | water | (0.2 g) | (0.1 g) | | (4 g) | | | | |
| | (100 g) | | | | | | | | |
| Example 4 | Deionized | dopa | Tris | 8.5 | graphene | 60 | 30 | good | 9.31 × 10⁴ |
| | water | (0.2 g) | (0.1 g) | | (4 g) | | | | |
| | (100 g) | | | | | | | | |
| Example 5 | Deionized | catechol | Tris | 8.5 | graphene | 60 | 30 | good | 1.06 × 10⁵ |
| | water | (0.2 g) | (0.1 g) | | (4 g) | | | | |
| | (100 g) | | | | | | | | |
| Example 6 | Deionized | dopamine | Tris | 8.5 | graphene | 60 | 30 | good | 3.23 × 10⁴ |
| | water | (1.0 g) | (0.1 g) | | (4 g) | | | | |
| | (100 g) | | | | | | | | |
| Example 7 | Deionized | dopamine | Tris | 8.5 | graphene | 270 | 30 | good | 1.21 × 10⁵ |
| | water | (0.2 g) | (0.1 g) | | (4 g) | | | | |
| | (100 g) | | | | | | | | |
| Example 8 | Deionized | dopamine | Tris | 8.5 | graphene | 60 | 80 | good | 8.15 × 10⁴ |
| | water | (0.2 g) | (0.1 g) | | (4 g) | | | | |
| | (100 g) | | | | | | | | |
| Comparative | Deionized | — | — | 7 | graphene | 60 | 30 | poor | 1.09 × 10⁵ |
| example 1 | water | | | | (4 g) | | | | |
| | (100 g) | | | | | | | | |
| Comparative | Deionized | fatty alcohol | — | 7 | graphene | 60 | 30 | good | 5.84 × 10⁻¹ |
| example 2 | water | sulfate | | | (4 g) | | | | |
| | (100 g) | (0.2 g) | | | | | | | |
| Comparative | Deionized | fatty alcohol | — | 7 | graphene | 60 | 30 | poor | 6.63 × 10⁻¹ |
| example 3 | water | ethoxylate | | | (4 g) | | | | |
| | (100 g) | (0.2 g) | | | | | | | |
| Comparative | Deionized | betaine(trimethyl | — | 7 | graphene | 60 | 30 | poor | 2.34 × 10⁻⁴ |
| example 4 | water | glycine) (0.2 g) | | | (4 g) | | | | |
| | (100 g) | | | | | | | | |

### [Test Example 1]—Evaluation of Dispersibility

The graphene prepared by Comparative example 1 and the graphene composite material prepared by Examples 1 to 8 and Comparative examples 2 to 4 were respectively placed in sample vials with water. The sample vials were slightly shaken and the dispersing conditions thereof were observed with bear eyes after 1 hour of standing. The dispersibility is considered good if the solution were homogeneously dispersed without stratification; on the other hand, the dispersibility is considered poor if the graphene or graphene composite material and water were stratified.

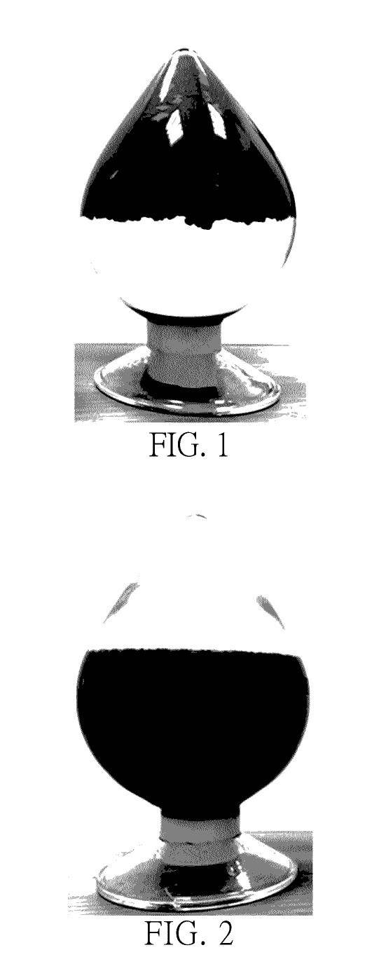

The dispersibility evaluation results of the graphene material prepared by Comparative example 1, and the graphene composite material prepared by Examples 1 to 8 and Comparative examples 2 to 4 are shown in Table 1. FIG. 1 shows the dispersing condition of the graphene prepared by Comparative example 1 and the graphene composite materials prepared by Comparative examples 3 and 4. The graphene or the graphene composite material are stratified with water in the sample vials, thus the dispersibility thereof are poor. FIG. 2 shows the dispersing condition of the graphene composite materials prepared by Examples 1 to 8 and Comparative example 2. The graphene composite materials homogeneously disperse with water, thus the dispersibility thereof are good.

### [Test Example 2]—Morphology Analysis

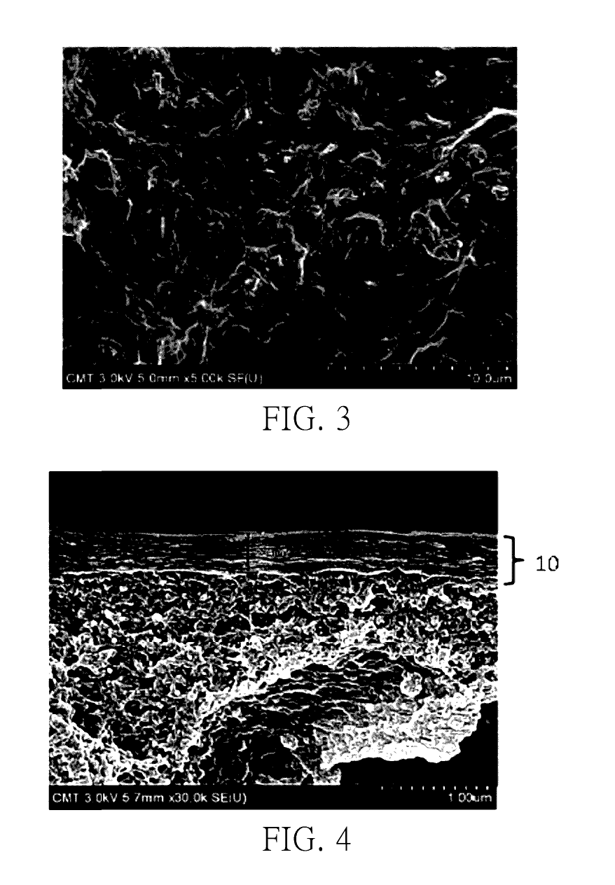

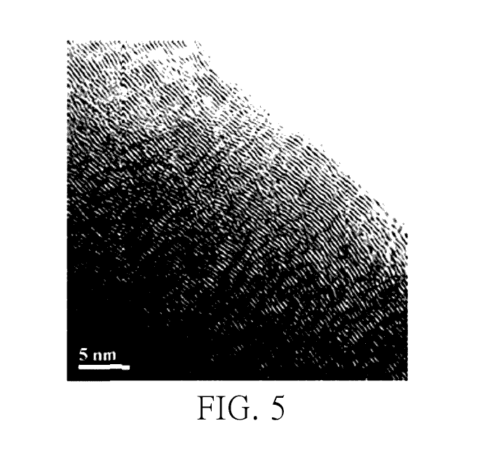

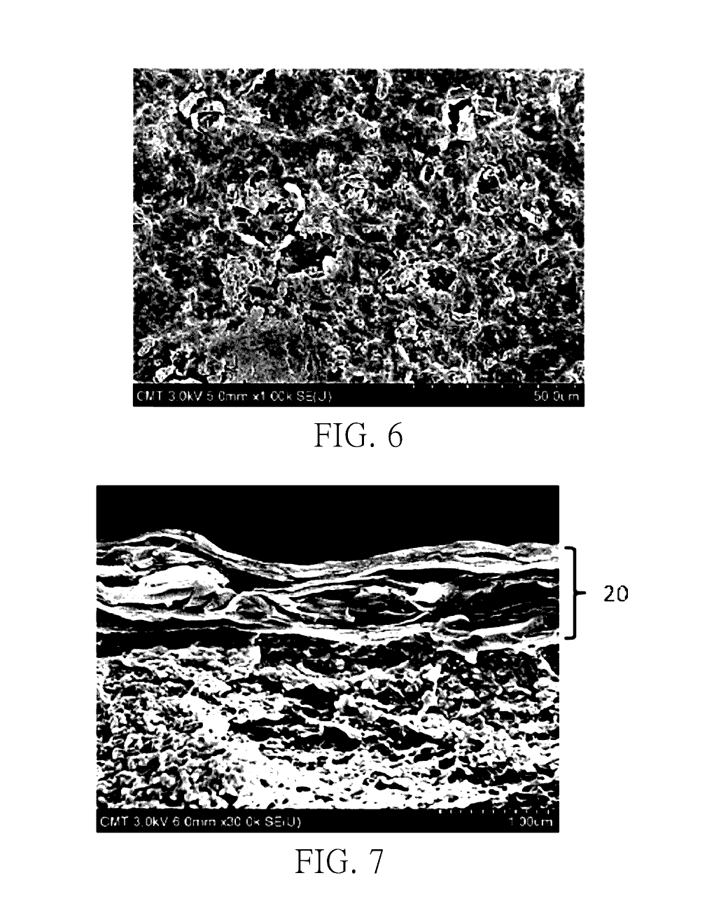

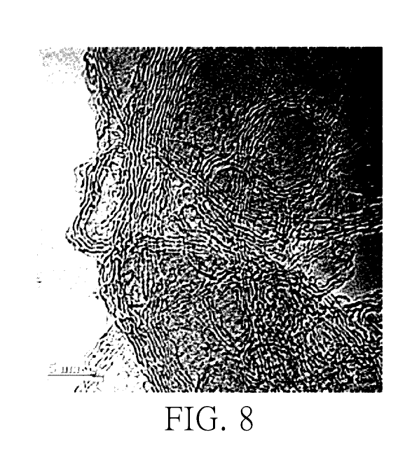

The morphology of the graphene composite material thin film prepared by Example 3 and the graphene thin film prepared by Comparative example 1 were examined by scanning electron microscopy (SEM) and transmission electron microscopy (TEM), wherein FIG. 3 shows the SEM image of the surface morphology of the graphene composite material thin film 10 prepared by Example 3; FIG. 4 shows the SEM image of the cross-section morphology of the graphene composite material thin film 10 prepared by Example 3 (the location of the graphene composite material thin film 10 is marked in FIG. 4); and FIG. 5 shows the TEM image of the graphene composite material thin film 10 prepared by Example 3. In addition, FIG. 6 shows the SEM image of the surface morphology of the graphene material thin film 20 prepared by Comparative example 1; FIG. 7 shows the SEM image of the cross-section morphology of the graphene material thin film 20 prepared by Comparative example 1 (the location of the graphene material thin film 20 is marked in FIG. 7); and FIG. 8 shows the TEM image of the graphene material thin film 20 prepared by Comparative example 1.

### [Test Example 3]—Evaluation of Electrical Conductivity

Four Point Sheet Resistance Meter (SR-H1000C, SAGE, VISION CO., LTD) was used for evaluating the electrical conductivity of the graphene thin film prepared by Comparative example 1 and the graphene composite material thin films prepared by Examples 1 to 8 and Comparative examples 2 to 4. The electrical conductivity of the graphene thin film prepared by Comparative example 1 and the electrical conductivity of the graphene composite material thin films prepared by Examples 1 to 8 and Comparative examples 2 to 4 are shown in Table 1.

According to the results of the evaluation of dispersibility of the graphene prepared by Comparative example 1 and the graphene composite materials prepared by Examples 1 to 8 and Comparative examples 2 to 4, it is obvious that the dispersibility of the graphene powder may be improved by adding the compounds having catechol group as shown in FIG. 2 (such as dopa, dopamine, and catechol). Hence, the graphene composite materials prepared by the Examples of the present invention are highly dispersible in water, thus the graphene composite material thin film prepared thereby may have a denser surface. Refer to FIGS. 3 to 5, the surface of the graphene composite material thin film prepared by Example 3 is dense and the graphene films therein are orderly arranged, thus the electrical conductivity thereof may be improved. In this regards, the graphene thin film prepared by Comparative example 1 as shown in FIGS. 6 to 8, the film structure thereof is loosely and randomly arranged, thus the quality of the graphene thin film is low with poor electrical conductivity.

In addition, although fatty alcohol ethoxylate was added as a cationic dispersing agent in Comparative example 3 and betaine(trimethylglycine) was added as a nonionic dispersing agent in Comparative example 4, they all failed to disperse the graphene composite material in water (as shown in FIG. 1) and resulting in poor electrical conductivity. Furthermore, fatty alcohol sulfate was added as a dispersing agent in Comparative example 2, and the graphene composite material prepared thereby had good dispersibility in water (as shown in FIG. 2), but the electrical conductivity of the graphene composite material thin film prepared thereby is largely decreased. In comparison, the graphene composite material modified using the compounds having catechol group may have an improved dispersibility, the excellent electrical conductivity thereof may still be maintained.

In Summary, according to the preparation method of a graphene composite material provided in the present invention, a graphene composite material having great dispersibility in water and a graphene composite material thin film having excellent electrical conductivity may be prepared, and are highly applicable in electronic products.

1. A preparation method of a graphene composite material comprising the steps of:
(A) providing a modification solution, wherein the modification solution comprises a compound having catechol group, and a first solvent;
(B) adding a graphene material into the modification solution; and
(C) mixing the graphene material and the modification solution to obtain a graphene composite material.

2. The preparation method as claimed in claim 1, wherein in step (A), the modification solution comprises 0.01 to 10 parts by weight of the compound having catechol group based on 100 parts by weight of the first solvent.

3. The preparation method as claimed in claim 1, wherein in step (A), the compound having catechol group is at least one selected from the group consisting of dopa, dopamine, catechol, norepinephrine, 3,4-dihydroxybenzoic acid, 3,4-dihydroxyphenyl acetic acid, caffeic acid, 4-methylcatechol, 4-tert-butylcatechol, salts thereof, and derivatives thereof.

4. The preparation method as claimed in claim 1, wherein in step (A), the first solvent is selected from the group consisting of water, alcohols, and a mixture thereof.

5. The preparation method as claimed in claim 1, wherein in step (A), the modification solution further comprises 0.01 to 1.5 parts by weight of a pH adjusting agent, such that the modification solution has a pH value of 6 to 11.

6. The preparation method as claimed in claim 5, wherein the pH adjusting agent is tris(hydroxymethyl)aminomethane (Tris).

7. The preparation method as claimed in claim 1, wherein in step (B), the amount of graphene material added into the modification solution is 1 to 7 parts by weight.

8. The preparation method as claimed in claim 1, further comprising step (D) removing the first solvent to obtain a graphene composite material powder.

9. The preparation method as claimed in claim 8, further comprising the steps of: (E1) distributing the graphene composite material powder in a second solvent to form a graphene composite material mixture solution; and
(E2) providing the graphene composite material mixture solution on a substrate, and removing the second solvent to obtain a graphene composite material thin film.

10. A graphene composite material, comprising:
70 to 99.9 wt % of a graphene material; and
0.1 to 30 wt % of a compound having catechol group;
wherein the graphene composite material is prepared by the preparation method claimed in claim 1, and the compound having catechol group is coated on a surface of the graphene material.

11. The graphene composite material as claimed in claim 10, wherein in step (A), the modification solution comprises 0.01 to 10 parts by weight of the compound having catechol group based on 100 parts by weight of the first solvent.

12. The graphene composite material as claimed in claim 10, wherein in step (A), the compound having catechol group is at least one selected from the group consisting of dopa, dopamine, catechol, norepinephrine, 3,4-dihydroxybenzoic acid, 3,4-dihydroxyphenyl acetic acid, caffeic acid, 4-methylcatechol, 4-tert-butylcatechol, salts thereof, and derivatives thereof.

13. The graphene composite material as claimed in claim 10, wherein in step (A), the first solvent is selected from the group consisting of water, alcohols, and a mixture thereof.

14. The graphene composite material as claimed in claim 10, wherein in step (A), the modification solution further comprises 0.01 to 1.5 parts by weight of a pH adjusting agent, such that the modification solution has a pH value of 6 to 11.

15. The graphene composite material as claimed in claim 14, wherein the pH adjusting agent is tris(hydroxymethyl)aminomethane (Tris).

16. The graphene composite material as claimed in claim 10, wherein in step (B), the amount of graphene material added into the modification solution is 1 to 7 parts by weight.

17. The graphene composite material as claimed in claim 10, further comprising step (D) removing the first solvent to obtain a graphene composite material powder.

18. The graphene composite material as claimed in claim 17, further comprising the steps of: (E1) distributing the graphene composite material powder in a second solvent to form a graphene composite material mixture solution; and
(E2) providing the graphene composite material mixture solution on a substrate, and removing the second solvent to obtain a graphene composite material thin film.
